(19) United States
(12) Patent Application Publication
(10) Pub. No.: US 2026/0327367 A1
(43) Pub. Date: Oct. 22, 2026

(54) XNBR POLYMER FORMED USING FREE RADICAL POLYMERIZATION AGENTS

(71) Applicant: Synthomer Sdn. Bhd., Johor Darul Takzim (MY)

(72) Inventors: Chi Hoong CHAN, Kulai, Johor (MY); Cecile FONTENEAU, Courtaboeuf Cedex (FR); Yi-Fan GOH, Kulai, Johor (MY); Olivier HINTIROGLOU, Courtaboeuf Cedex (FR); Zhenli WEI, Kulai, Johor (MY); Sophie DRILLIERES, Courtaboeuf Cedex (FR)

(73) Assignee: Synthomer Sdn. Bhd., Johor Darul Takzim (MY)

(21) Appl. No.: 19/099,563

(22) PCT Filed: Jul. 5, 2023
(86) PCT No.: PCT/EP2023/068523

§ 371 Date: Jan. 29, 2025

(30) Foreign Application Priority Data
Aug. 4, 2022 (MY) PI2022004161

(51) Int. Cl. C08F 293/00

(52) U.S. Cl. CPC C08F 293/005; C08F 2438/03; C08F 2800/20

(57) ABSTRACT

The present invention relates to a polymer latex comprising a copolymer, to a method for the preparation of such a polymer latex, to the use of said polymer latex for the production of rubber articles, and to articles made by using said polymer latex.

The present invention relates to a polymer latex, a method for obtaining the polymer latex and the use of the polymer latex for the preparation of rubber articles. The present invention also relates to a rubber article prepared from such polymer latex or from a polymer latex prepared by such method.

### BACKGROUND OF THE INVENTION

XNBR (carboxylated nitrile butadiene rubber) has been known in the art for years. Such rubbers are commonly produced by free radical emulsion polymerization of butadiene, an ethylenically unsaturated having a nitrile group and an ethylenically unsaturated having a carboxyl group.

This procedure however has several disadvantages. Firstly, the distribution of the monomers present in the obtained rubber is random, which does not allow for specific monomer distributions throughout the final polymer, for example wherein a certain monomer should be advantageously be distributed towards one or both ends of the polymer chain. This issue can be partially overcome by providing a block copolymer; however, this procedure often requires multiple polymerization steps, which is inefficient and therefore undesired.

Additionally, conventional emulsion polymerization requires the presence of a surfactant to enable the formation of micelles, in which the polymerization can take place. However, the presence of a surfactant in the obtained polymer latex often causes issues during the following production of several rubber articles, e.g. nitrile rubber gloves. The surfactant therefore needs to be at least partially removed from the obtained polymer latex, which requires a large volume of water. For the production of 1000 gloves, approximately 300 to 400 liters of water are required.

There is consequently a need to overcome the disadvantages of the processes known in the art for both economic and ecologic reasons.

It is therefore an object of the present invention to provide a polymer latex which monomer distribution can be specifically manipulated, and which does not compellingly require the presence of a surfactant during its production, thereby allowing for more economical and ecologically friendly method of production.

### SUMMARY OF THE INVENTION

The following clauses summarize some aspects of the present invention.

According to a first aspect, the present invention relates to a polymer latex comprising a copolymer obtainable by free radical emulsion polymerization of a mixture of compounds comprising:
(a) a macro-reversible addition-fragmentation chain-transfer (macro-RAFT) agent obtainable by free radical polymerization of a RAFT agent (a1) with an ethylenically unsaturated monomer having at least one acid, hydroxyl, ester, ether, amine, sulphonate and/or amide functional group (a2),
(b) an ethylenically unsaturated monomer having a nitrile functional group; and
(c) a conjugated diene monomer.

The mixture of compounds may further comprise
(d) an ethylenically unsaturated monomer having at least one acid, hydroxyl, ester, ether, amine, sulphonate and/or amide functional group. In particular, the compounds (d) may be an ethylenically unsaturated monomer having at least carboxylic acid, ester, ether, sulphonate, hydroxyl, primary amine, secondary amine or sulphate functional group.

The RAFT agent (a1) may comprise a compound having a thiocarbonyl functional group.

The thiocarbonyl functional group may comprise a trithiocarbonate, dithioester, a thiocarbamate and/or a xanthate functional group.

The macro-RAFT agent (a) may be capable of inducing polymerization induced self-assembly (PISA).

Monomer (b) may comprise monomers having a total number of 3 to 10 carbon atoms and combinations thereof, preferably acrylonitrile, butyronitrile and combinations thereof, more preferably acrylonitrile.

Monomer (c) may comprise 1,3-butadiene, isoprene, 2,3-dimethyl-1,3-butadiene, 2-chloro-1,3-butadiene, 1,3-pentadiene, 1,3-hexadiene, 2,4-hexadiene, 1,3-octadiene, 2-methyl-1,3-pentadiene, 2,3-dimethyl-1,3-pentadiene, 3,4-dimethyl-1,3-hexadiene, 2,3-diethyl-1,3-butadiene, 4,5-diethyl-1,3-octadiene, 3-butyl-1,3-octadiene, 3,7-dimethyl-1,3,6-octatriene, 2-methyl-6-methylene-1,7-octadiene, 7-methyl-3-methylene-1,6-octadiene, 1,3,7-octatriene, 2-ethyl-1,3-butadiene, 2-amyl-1,3-butadiene, 3,7-dimethyl-1,3,7-octatriene, 3,7-dimethyl-1,3,6-octatriene, 3,7,11-trimethyl-1,3,6,10-dodecatetraene, 7,11-dimethyl-3-methylene-1,6,10-dodecatriene, 2,6-dimethyl-2,4,6-octatriene, 2-phenyl-1,3-butadiene, 2-methyl-3-isopropyl-1,3-butadiene, 1,3-cyclohexadiene, myrcene, ocimene, farnasene and combinations thereof, preferably 1,3-butadiene, isoprene and combinations thereof, more preferably 1,3-butadiene.

Monomers (a2) and/or (d) may comprise monomers of the general formula R¹C(═CH₂)R²X, wherein R¹ is H, methyl or ethyl, R² is an optional, linear or branched spacer group having 1 to 5 carbon atoms, and X is a carboxylic acid, ester, ether, sulphonate, hydroxyl, primary amine, secondary amine or sulphate functional group, preferably R¹ is H or methyl and X is a carboxylic acid, more preferably monomers (a2) and/or (d) comprise acrylic acid or methacrylic acid, most preferably monomers (a2) and/or (d) comprise methacrylic acid.

The copolymer may comprise sections having an X—Y structure or an X—Y—Z structure.

Section Y may have a random or block structure comprising monomers (b) and (c), wherein optionally section Y further comprises monomers (a2) and/or (d).

Section X and, if present, section Z may comprise monomers (a2) and/or (d), preferably wherein sections X and Z do not contain monomers (b) and (c).

The content of monomer (b) in the mixture of compounds may be from 15 to 60 parts by weight, preferably 20 to 50 parts by weight, based on the weight of mixture of compounds.

The content of monomer (c) in the mixture of compounds may be from 40 to 90 parts by weight, preferably 50 to 80 parts by weight, based on the weight of mixture of compounds.

The macro-RAFT agent (a) may be present in an amount between 1.5 and 10 parts by weight, preferably between 1.75 and 8 parts by weight, more preferably between 2 and 6 parts by weight, based on the weight of mixture of compounds.

Monomer (d) may be present in an amount between 0.5 and 20 parts by weight, preferably between 1 and 15 parts by weight, more preferably between 1.5 and 10 parts by weight, based on the weight of mixture of compounds.

The polymer latex may further comprise a surfactant, wherein the surfactant content in the polymer latex may be less than 5 parts by weight, preferably less than 3.5 parts by weight, more preferably less than 3 parts by weight, most preferred less than 2.5 parts by weight, based on the total weight of the polymer latex.

The polymer latex may be a surfactant-free polymer latex.

According to a second aspect, the present invention relates to a method for producing a polymer latex comprising a block copolymer, the method comprising the steps of
(1) free radical polymerization a RAFT agent (a1) with an ethylenically unsaturated monomer having at least one acid, hydroxyl, ester, ether, amine, sulphonate and/or amide functional group (a2) to receive a macro-RAFT agent (a),
(2) RAFT-mediated emulsion polymerization of a mixture of compounds comprising:
(a) the macro-RAFT agent (a) received in step (1)
(b) an ethylenically unsaturated monomer having a nitrile functional group; and
(c) a conjugated diene monomer
to obtain the polymer latex.

The method may further comprise adding at least one ethylenically unsaturated monomer having at least one acid, hydroxyl, ester, amine and/or amide functional group (a2) and/or (d) to the reaction mixture during and/or after step (2), preferably wherein monomer (a2) and/or (d) is an ethylenically unsaturated monomer having at least one acid, hydroxyl, ester, ether, amine, sulphonate and/or amide functional group, more preferably wherein monomers (a2) and (d) comprise monomers of the general formula R¹C(═CH₂)R²X, wherein R¹ is H, methyl or ethyl, R² is an optional, linear or branched spacer group having 1 to 5 carbon atoms, and X is a carboxylic acid, ester, ether, sulphonate, hydroxyl, primary amine, secondary amine or sulphate functional group, preferably R¹ is H or methyl and X is a carboxylic acid, more preferably monomers (a2) and/or (d) comprise acrylic acid or methacrylic acid, most preferably monomers (a2) and/or (d) comprise methacrylic acid.

Monomers (b), (c) and (d) may be charged by batch, semi-batch, continuous, split charging or split injection.

According to the second aspect, at least one of the following may be fulfilled:
(i) the ethylenically unsaturated monomer having at least one acid, hydroxyl, ester, ether, amine, sulphonate and/or amide functional group (a2) comprises monomers as defined above;
(ii) monomer (b) is a monomer as defined above;
(iii) monomer (c) is a monomer as defined above;
(iv) monomer (d) is an ethylenically unsaturated monomer having at least one acid, hydroxyl, ester, ether, amine, sulphonate and/or amide functional group, preferably a monomer of the general formula R¹C(═CH₂)R²X, wherein R¹ is H, methyl or ethyl, R² is an optional, linear or branched spacer group having 1 to 5 carbon atoms, and X is a carboxylic acid, ester, ether, sulphonate, hydroxyl, primary amine, secondary amine or sulphate functional group, preferably R¹ is H or methyl and X is a carboxylic acid, more preferably monomer (d) comprises acrylic acid or methacrylic acid, most preferably monomer (d) comprises methacrylic acid; and/or
(v) the copolymer comprises sections as defined above.

According to a second aspect, no surfactants may be added before, during or after steps (1) and (2).

According to a second aspect, no seeding agents may be added before, during or after steps (1) and (2).

The polymerization of step (2) may be carried out at a temperature between 5° C. to 95° C. preferably 30° C. and 60° C.

In a third aspect, the present invention relates to the use of the polymer latex according to any clauses of the first aspect, or prepared by the method according to any clauses of the second aspect for the preparation of rubber articles.

The rubber articles may comprise surgical gloves, examination gloves, condoms, catheters, industrial gloves, textile-supported gloves, household gloves balloons, tubing, dental dams, aprons and pre-formed gaskets.

In a fourth aspect, the present invention relates to a rubber article prepared from the polymer latex according to any clauses of the first aspect or from a polymer latex prepared by the method according to any clauses of the second aspect.

The rubber article may comprise a surgical glove, an examination glove, a condom, a catheter, an industrial glove, a textile-supported glove, a household glove balloon, a tubing, a dental dam, an apron and a pre-formed gasket.

### DETAILED DESCRIPTION OF THE INVENTION

The present invention relates to a polymer latex, which is useful for the production of rubber articles. The polymer latex polymer latex comprises a copolymer, which is obtainable by free radical emulsion polymerization of a mixture of compounds. This mixture of compounds comprises (a) a macro-reversible addition-fragmentation chain-transfer (macro-RAFT) agent, (b) an ethylenically unsaturated monomer having a nitrile functional group, and (c) a conjugated diene monomer. The macro-RAFT agent (a) is obtainable by free radical polymerization of a RAFT agent (a1) with an ethylenically unsaturated monomer having at least one acid, hydroxyl, ester, ether, sulphonate and/or amide functional group (a2). The mixture of compounds preferably further comprises (d) an ethylenically unsaturated monomer having at least one acid, hydroxyl, ester, ether, sulphonate and/or amide functional group.

It has surprisingly been found that by using a macro-reversible addition-fragmentation chain-transfer (macro-RAFT) agent (a) as an additional component during the production of a polymer latex by free radical emulsion polymerization, a stable polymer latex can be obtained, although only smaller amounts of surfactant compared to conventional emulsion polymerization, or even no surfactant, is being present in the mixture of compounds during the polymerization, due to polymerization-induced self-assembly (PISA). A further benefit of the present invention is that the copolymer being present in the inventive polymer latex can be specifically designed by the manufacturer, i.e. the monomer distribution in the copolymer can be manipulated, depending on the amount and time the respective monomers are added to the mixture of compounds during the process of polymerization.

The macro-RAFT agent (a) can be obtained by free radical polymerization of a RAFT agent (a1) with an ethylenically unsaturated monomer having at least one acid, hydroxyl, ester, ether, sulphonate and/or amide functional group (a2).

The macro-RAFT agent (a) may have a Mw of at least 500 g/mol, preferably 750 g/mol, more preferably 1000 g/mol and no more than 5000 g/mol, preferably 4750 g/mol, more preferably 4500 g/mol. A person skilled in the art will understand that any range formed by any of the explicitly disclosed lower limits and upper limits is explicitly encompassed in the present specification. The macro-RAFT agent (a) may therefore particularly have a Mw from 500 g/mol to 5000 g/mol, preferably 750 g/mol to 4750 g/mol, more preferably 1000 g/mol to 4500 g/mol. A skilled person will appreciate that the Mw can be measured using techniques commonly known in the art, including size exclusion chromatography using a suitable standard, as well as mass spectrometry.

The macro-RAFT agent (a) may be present in the mixture of compounds in an amount between 1 and 10 parts by weight, preferably between 1.75 and 8 parts by weight, more preferably between 2 and 6 parts by weight, based on the weight of the mixture of compounds. The lower limit of the amount of macro-RAFT agent (a) therefore can be 1, 1.50, 1.55, 1.60, 1.65, 1.70, 1.75, 1.80, 1.85, 1.90, 1.95, or 2.0 parts by weight, based on the weight of mixture of compounds. The upper limit of the amount can be 10, 9.5, 9, 8.5, 8, 7.5, 7, 6.5, or 6 parts by weight, based on the weight of mixture of compounds. A person skilled in the art will understand that any range formed by any of the explicitly disclosed lower limits and upper limits is explicitly encompassed in the present specification.

The RAFT agent (a1) may comprise a compound having a thiocarbonyl functional group. Preferably, the thiocarbonyl functional group may comprise a trithiocarbonate, dithioester, a thiocarbamate and/or a xanthate functional group. Commercially available examples of RAFT agents (a1) comprise, for example, 4-((((2-carboxyethyl)thio)carbonothioyl)thio)-4-cyanopentanoic acid, 4-((((2-carboxyethyl)thio)carbonothioyl)thio)-4-acetamidepentanoic acid, 2,2′-[carbonothioylbis(thio)]bis[2-methylpropanoic acid], 3-((((1-carboxyethyl)thio)carbonothioyl)thio)propanoic acid, bis(dodecylsulfanyl thiocarbonyl)disulfide, cyanomethyl (3,5-Dimethyl-1H-pyrazole)-carbodithioate and dibenzyl trithiocarbonate. However, a skilled person will appreciate that any RAFT agent may be suitable for obtaining the polymer latex according to the present invention.

Monomer (a2) and/or optionally present monomer (d) may be the same or different monomers. These monomers may be preferably selected from ethylenically unsaturated acids and salts thereof, hydroxy functional ethylenically unsaturated monomers, ethylenically unsaturated monomers bearing a primary or secondary amino group, ethylenically unsaturated monomers bearing an amide group, hydroxylamine functional ethylenically unsaturated monomers, glycol functional ethylenically unsaturated monomers, and combinations thereof.

Ethylenically unsaturated acids and salts thereof may preferably be selected from (meth)acrylic acid, crotonic acid, itaconic acid, maleic acid, fumaric acid, ethylenically unsaturated sulfonic acids, ethylenically unsaturated phosphorous containing acids and salts thereof, polycarboxylic acid anhydrides, polycarboxylic acid partial ester monomers, carboxy alkyl esters of ethylenically unsaturated acids, and combinations thereof.

Hydroxy functional ethylenically unsaturated monomers may preferably be selected from allyl alcohol, vinyl alcohol, N-methylolacrylamide, 1-penten-3-ol, hydroxyalkyl esters of ethylenically unsaturated acids, hydroxyethyl methacrylate, hydroxypropyl methacrylate, hydroxyethyl acrylate and combinations thereof.

Ethylenically unsaturated monomers bearing a primary amino group, a secondary amino group and/or an amide group may preferably be selected from (meth)acrylamide, 2-amino ethyl (meth)acrylate hydrochloride, 2-amino ethyl (meth) acrylamide hydrochloride, N-ethyl (meth)acrylamide, N-(3-amino propyl) (meth)acrylamide hydrochloride, N-hydroxyethyl (meth)acrylamide, N-3-(dimethylamino) propyl (meth)acrylamide, [3-(methacryloylamino)propyl]trimethylammonium salts, N-[tris(hydroxymethyl) methyl](meth)acrylamide, N-phenylacrylamide, alkylacrylamide, methacrylamide, poly(ethylene glycol) amine hydrochloride, and combinations thereof.

Hydroxylamine functional ethylenically unsaturated monomers may preferably be selected from acrylohydroxamic acid.

Glycol functional ethylenically unsaturated monomers may preferably be selected from ethylene glycol methyl ether (meth)acrylate, ethylene glycol phenyl ether (meth)acrylate, di(ethylene glycol) methyl ether (meth)acrylate, tri(ethylene glycol) methyl ether (meth)acrylate, poly(ethylene glycol) methyl ether (meth)acrylate, poly(ethylene glycol) phenyl ether acrylate, poly(ethylene glycol) (meth)acrylate, poly(propylene glycol) (meth)acrylate poly(ethylene glycol)-block-poly(propylene glycol)-block-poly(ethylene glycol) (meth)acrylate, polyglycol partial ester monomer, and combinations thereof.

More preferably, monomer (a2) and/or optionally present monomer (d) comprise monomers of the general formula R¹C(═CH₂)R²X, wherein R¹ is H, methyl or ethyl, R² is an optional, linear or branched spacer group having 1 to 5 carbon atoms, and X is a carboxylic acid, ester, ether, sulphonate, hydroxyl, primary amine, secondary amine or sulphate functional group, more preferably R1 is H or methyl and X is a carboxylic acid, even more preferably monomers (a2) and/or (d) comprise acrylic acid or methacrylic acid, most preferably monomers (a2) and/or (d) comprise methacrylic acid.

Monomer (b) may comprise monomers having a total number of 3 to 10 carbon atoms and combinations thereof. Such monomers may comprise acrylonitrile, methacrylonitrile, fumaronitrile, butyronitrile, and combinations thereof, preferably acrylonitrile and/or methacrylonitrile, more preferably acrylonitrile.

Monomer (b) may be present in the mixture of compounds from 15 to 60 parts by weight, preferably 20 to 50 parts by weight, based on the weight of mixture of compounds. The lower limit of the amount of monomer (b) therefore can be 15, 16, 17, 18, 19, or 20 parts by weight, based on the weight of mixture of compounds. The upper limit of the amount can be 60, 59, 58, 57, 56, 55, 54, 53, 52, or 51 parts by weight, based on the weight of mixture of compounds. A person skilled in the art will understand that any range formed by any of the explicitly disclosed lower limits and upper limits is explicitly encompassed in the present specification.

Monomer (c) may comprise 1,3-butadiene, isoprene, 2,3-dimethyl-1,3-butadiene, 2-chloro-1,3-butadiene, 1,3-pentadiene, 1,3-hexadiene, 2,4-hexadiene, 1,3-octadiene, 2-methyl-1,3-pentadiene, 2,3-dimethyl-1,3-pentadiene, 3,4-dimethyl-1,3-hexadiene, 2,3-diethyl-1,3-butadiene, 4,5-diethyl-1,3-octadiene, 3-butyl-1,3-octadiene, 3,7-dimethyl-1,3,6-octatriene, 2-methyl-6-methylene-1,7-octadiene, 7-methyl-3-methylene-1,6-octadiene, 1,3,7-octatriene, 2-ethyl-1,3-butadiene, 2-amyl-1,3-butadiene, 3,7-dimethyl-1,3,7-octatriene, 3,7-dimethyl-1,3,6-octatriene, 3,7,11-trimethyl-1,3,6,10-dodecatetraene, 7,11-dimethyl-3-methylene-1,6,10-dodecatriene, 2,6-dimethyl-2,4,6-octatriene, 2-phenyl-1,3-butadiene, 2-methyl-3-isopropyl-1,3-butadiene, 1,3-cyclohexadiene, myrcene, ocimene, farnasene and combinations thereof. Preferably, monomer (c) comprises 1,3-butadiene, isoprene and combinations thereof. More preferably, monomer (c) comprises 1,3-butadiene.

Monomer (c) may be present in the mixture of compounds from 40 to 90 parts by weight, preferably 50 to 80 parts by weight, based on the weight of mixture of compounds. The lower limit of the amount of monomer (c) therefore can be 40, 41, 42, 43, 44, 45, 4, 47, 48, 49 or 50 parts by weight, based on the weight of mixture of compounds. The upper limit of the amount can be 90, 89, 88, 87, 86, 85, 84, 83, 82, 81 or 80 parts by weight, based on the weight of mixture of compounds. A person skilled in the art will understand that any range formed by any of the explicitly disclosed lower limits and upper limits is explicitly encompassed in the present specification.

The amounts of the macro-RAFT agent (a) and monomers (b), (c) and, if present, (d) may add up to 100 parts by weight, based on the weight of mixture of compounds.

The copolymer according to the present invention may comprise sections. Sections according to the present invention may be regions within the copolymer. These sections may have an X—Y structure or an X—Y—Z structure. Sections according to the present invention may have a random structure, in which the respective monomer residues are distributed in a random manner within the respective section, or a block structure, wherein the respective monomer residues are distributed in the form of at least two blocks, preferably two or three blocks. A skilled person will therefore acknowledge that, although the whole polymer may not compellingly be a block copolymer, the polymer may comprise sections, i.e. regions within its structure, which have a block structure.

Section X and, if present, section Z may comprise monomers (a2) and/or (d), preferably wherein sections X and Z do not contain monomers (b) and (c).

Section Y may have a random or block structure comprising monomers (b) and (c), wherein optionally section Y further comprises monomers (a2) and/or (d).

Monomer (d) may be present in an amount between 0 and 20 parts by weight, preferably between 0 and 15 parts by weight, more preferably between 0 and 10 parts by weight, based on the weight of mixture of compounds. This particularly includes 0, 0.5, 1, 2, 3, 4, 5, 6, 7, 8, 9 and 10 parts by weight, based on the weight of mixture of compounds. A person skilled in the art will understand that any range formed by any of the explicitly disclosed values is explicitly encompassed in the present specification. As the amount of monomer (d) may be 0 parts by weight, based on the weight of mixture of compounds, a skilled person understands that the mixture of compounds may not comprise monomer (d).

The polymer latex may further comprise at least one surfactant. Alternatively, the polymer latex may be a surfactant-free polymer latex. A skilled person will appreciate that, despite efforts being undertaken not to add any surfactants to the mixture of compounds or the obtained polymer latex, trace amounts of surfactant may be present in the surfactant-free polymer latex.

Accordingly, a surfactant-free polymer latex may contain between 0 and 0.05 parts by weight, preferably between 0 and 0.005 part by weight, based on 100 parts by weight of the polymer latex, of one or more surfactants.

In case one or more surfactants are used, surfactants or emulsifiers which are suitable for stabilizing the polymer dispersion may include those conventional surface-active agents for polymerization processes. The surfactant or surfactants can be added to the aqueous phase and/or the monomer phase. An effective amount of surfactant in a seed process is the amount which was chosen for supporting the stabilization of the particle as a colloid, the minimization of contact between the particles and the prevention of coagulation. In a non-seeded process, an effective amount of surfactant is the amount which was chosen for determining the particle size.

Representative surfactants may include saturated and ethylenically unsaturated sulfonic acids or salts thereof, including, for example, unsaturated hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of acrylic acid and methacrylic acid, such as, for example, sulfoethyl methacrylate and sulfopropyl methacrylate and salts thereof, and 2-acrylamido-2-methylpropanesulfonic acid and salts thereof; alkylated diphenyl oxide disulfonates, C10-13 alkyl benzene sulfonates, sodium dodecylbenzenesulfonates, sulphonated naphthalene formaldehyde condensate and dihexyl or dioctyl esters of sodium sulfosuccinate, sodium alkyl esters of sulfonic acid, ethoxylated alkylphenols and ethoxylated alcohols; fatty alcohol sulfates, fatty alcohol (poly)ether sulfates and mixture thereof. Often, surfactants are used in blends in polymerization and these are preferably C₁₀-C₁₃ chain length alkyl benzene sulfonates, which may be branched or linear.

The type and the amount of the surfactant is governed typically by the number of particles, their size and their composition. Accordingly, the at least one surfactant can be used in amounts of less than 5 parts by weight, preferably less than 3.5 parts by weight, more preferably less than 3 parts by weight, even more preferred less than 2.5 parts by weight and most preferred less than 0.9 parts by weight, based on the total weight of the polymer latex. The lower limit of the amount of surfactant may be at least 0.4 part by weight, preferably at least 0.5 parts by weight, more preferably at least 0.6 parts by weight, even more preferred at least 0.7 parts by weight and most preferred at least 0.8 parts by weight, based on the total weight of the polymer latex. Consequently, the amount of surfactant may range between 0.4 and 5 parts by weight, preferably between 0.5 and 3.5 parts by weight, more preferably between 0.6 and 3 parts by weight, even more preferred 0.7 and 2.5 parts by weight and most preferred between 0.8 and 0.9 parts by weight, based on the total weight of the polymer latex. The amount of surfactant includes all values and sub-values there between, especially including 0.4, 0.5, 0.6, 0.7, 0.8, 0.9, 1, 1,5, 2, 2.5, 3, 3.5, 4, 4.5 and 5 parts by weight, based the total weight of the polymer latex.

It is particularly preferred that, in case monomer (d) the polymer latex is obtained by free radical polymerization of a mixture of compounds additionally comprising monomer (d), the polymer latex comprises at least one surfactant, wherein the at least one surfactant is present an amount as indicated above.

According to the present invention, the polymer latex may have a median particle size of at least 50 nm, preferably at least 60 nm, more preferably of at least 70 nm.

The polymer latex may have a median particle size of no more than 200 nm, such as no more than 180 nm, or no more than 160 nm. A person skilled in the art will appreciate that any range between any of the explicitly disclosed lower and upper limit is herein disclosed. Accordingly, the polymer latex may have a median particle size in a range of 50 nm to 200 nm, preferably 60 nm to 180 nm, more preferably 70 nm to 160 nm. The median particle size can be determined by dynamic light scattering according to ISO 22412:2017, e.g., with the dynamic light scattering instrument Mastersizer 2000 (Malvern Panalytical (UK)).

### Method for Preparing the Inventive Polymer Latex

As mentioned above, according to the present invention, a method for producing a polymer latex comprising a copolymer comprises the steps of
(1) free radical polymerization a RAFT agent (a1) with an ethylenically unsaturated monomer having at least one acid, hydroxyl, ester, amine and/or amide functional group (a2) to receive a macro-RAFT agent (a),
(2) RAFT-mediated emulsion polymerization of a mixture of compounds comprising:
(a) the macro-RAFT agent (a) received in step (1)
(b) an ethylenically unsaturated monomer having a nitrile functional group; and
(c) a conjugated diene monomer
   to obtain the polymer latex.

In the emulsion polymerization for preparing the polymer latex of the present invention, a seed dispersion may be employed. Any dispersed seed particles as known to the person skilled in the art can be used. However, the inventive process does not compellingly require seed particles in order to obtain the inventive polymer latex. It is therefore preferred that no seeding agents are added before, during or after steps (1) and (2)

In case seed particles are employed, the seed particles are preferably present in an amount of 0.01 to 10 parts by weight, preferably 0.1 to 5 parts by weight, based on 100 parts by weight of total ethylenically unsaturated monomers employed in the polymer. The lower limit of the amount of seed particles therefore can be 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 parts by weight. The upper limit of the amount can be 10, 9, 8, 7, 6, 5.5, 5, 4.5, 4, 3.8, 3.6, 3.4, 3.3, 3.2, 3.1 or 3 parts by weight. A person skilled in the art will understand that any range formed by any of the explicitly disclosed lower limits and upper limits is explicitly encompassed in the present specification.

The method according to the present invention may additionally comprise a step of shortstopping the polymerization. This may be desired in order to control the molecular weight of the resulting copolymer and consequently the physical properties. A shortstop can usually be initiated by adding an appropriate amount of a shortstopping agent. A skilled person will acknowledge that a shortstopping agent will inhibit the formation of radicals by the activator and the propagation of polymer chain. Therefore, the free radical polymerization will be stopped by destruction of the initiator, by prevention of propagation, or by termination of the growing alkyl radical. A suitable shortstopping agent may be selected such that it that works on all three mechanisms.

The shortstop may be initiated when at least 50% conversion has occurred, based on the desired properties of the polymer latex.

The process for the preparation of the above-described polymer latex may be performed at temperatures of from 5 to 95° C., preferably of from 15 to 80° C., particularly preferably of from 30 to 60° C., preferably in the presence of no or one or more emulsifiers, no or one or more protective colloids and one or more initiators. The temperature includes all values and sub-values therebetween, especially including 5, 10, 15, 20, 25, 30, 35, 40, 45, 50, 55, 60, 65, 70, 75, 80, 85, 90, 95° C. The temperature may be varied or remain constant during the polymerization process. In case the temperature is varied, it may be increased or decreased, as long as it remains within the temperature range defined above between the initiation and ending, or shortstop, of the reaction.

Initiators which can be used when carrying out the present invention may include water-soluble and/or oil-soluble initiators which are effective for the purposes of the polymerization. Representative initiators are well known in the technical area and include, for example: azo compounds (such as, for example, Azobisisobutyronitrile (AIBN), 2,2′-Azodi(2-methylbutyronitrile) (AMBN), 4,4′-Azobis(4-cyanopentanoic acid) (ACPA), and cyanovaleric acid) and inorganic peroxy compounds, such as hydrogen peroxide, sodium, potassium and ammonium peroxydisulfate, peroxycarbonates and peroxyborates, as well as organic peroxy compounds, such as alkyl hydroperoxides, dialkyl peroxides, acyl hydroperoxides, and diacyl peroxides, as well as esters, such as tert-butyl perbenzoate and combinations of inorganic and organic initiators. Suitable initiators may be selected from 2,3-dimethyl-2,3-diphenylbutane, tert-butyl hydroperoxide, tert-amyl hydroperoxide, cumyl hydroperoxide, 1,1,3,3-tetramethylbutyl hydroperoxide, isopropylcumyl hydroperoxide, p-menthane hydroperoxide, 2,5-di(tert-butylperoxy)-2,5-dimethyl-3-hexyne, 3,6,9-triethyl-3,6,9-trimethyl-1,4,7-triperoxonane, di(tert-butyl)peroxide, 2,5-dimethyl-2,5-di(tert-butylperoxy)hexane, di(tert-butylperoxy-isopropyl)benzene, tert-butyl cumyl peroxide, di-(tert-amyl)-peroxide, dicumyl peroxide, butyl 4,4-di(tert-butylperoxy)valerate, tert-butylperoxybenzoate, 2,2-di(tert-butylperoxy)butane, tert-amyl peroxy-benzoate, tert-butylperoxy-acetate, tert-butylperoxy-(2-ethylhexyl)carbonate, tert-butylperoxy isopropyl carbonate, tert-butyl peroxy-3,5,5-trimethyl-hexanoate, 1,1-di(tert-butylperoxy)cyclohexane, tert-amyl peroxyacetate, tert-amylperoxy-(2-ethylhexyl)carbonate, 1,1-di(tert-butylperoxy)-3,5,5-trimethylcyclohexane, 1,1-di(tert-amylperoxy)cyclohexane, tert-butyl-monoperoxy-maleate, 1,1′-azodi(hexahydrobenzonitrile), tert-butyl peroxy-isobutyrate, tert-butyl peroxydiethylacetate, tert-butyl peroxy-2-ethylhexanoate, dibenzoyl peroxide, tert-amyl peroxy-2-ethylhexanoate, di(4-methylbenzoyl)peroxide, 1,1,3,3-tetramethylbutyl peroxy-2-ethylhexanoate, ammonium peroxodisulfate, 2,5-dimethyl-2,5-di(2-ethylhexanoylperoxy)hexane, 2,2′-azodi(2-methylbutyronitrile), 2,2′-azodi(isobutyronitrile), didecanoyl peroxide, potassium persulfate, dilauroyl peroxide, di(3,5,5-trimethylhexanoyl) peroxide, tert-amyl peroxypivalate, tert-butyl peroxyneoheptanoate, 1,1,3,3-tetramethylbutyl peroxypivalate, tert-butyl peroxypivalate, dicetyl peroxydicarbonate, dimyristyl peroxydicarbonate, di(2-ethylhexyl) peroxydicarbonate, di(4-tert-butylcyclohexyl) peroxydicarbonate, diisopropyl peroxydicarbonate, tert-butyl peroxyneodecanoate, di-sec-butyl peroxydicarbonate, tert-amyl peroxyneodecanoate, cumyl peroxyneoheptanoate, di(3-methoxybutyl) peroxydicarbonate, 1,1,3,3-tetramethylbutyl peroxyneodecanoate, cumyl peroxyneodecanoate, diisobutyryl peroxide, and mixtures thereof.

The initiator may be used in a sufficient amount to initiate the polymerization reaction at a desired rate. In general, an amount of initiator of from 0.01 to 5 wt.-%, preferably of from 0.1 to 4 wt.-%, based on the total weight of compounds (a), (b) and (c) in the mixture of compounds, is sufficient. The amount of initiator is most preferably of from 0.01 to 2 wt.-%, based on the total weight of compounds (a), (b) and (c) in the mixture of compounds. The amount of initiator includes all values and sub-values therebetween, especially including 0.01, 0.1, 0.5, 1, 1.5, 2, 2.5, 3, 4 and 4.5 wt.-%, based on the total weight of compounds (a), (b) and (c) in the mixture of compounds.

The above-mentioned inorganic and organic peroxy compounds may also be used alone or in combination with one or more suitable reducing agents, as is well known in the art. Examples of such reducing agents may include sulfur dioxide, alkali metal disulfites, alkali metal and ammonium hydrogen sulfites, thiosulfates, dithionites and formaldehyde sulfoxylates, as well as hydroxylamine hydrochloride, hydrazine sulfate, iron (II) sulfate, cuprous naphthanate, glucose, sulfonic acid compounds such as sodium methane sulfonate, amine compounds such as dimethylaniline and ascorbic acid. The quantity of the reducing agent is preferably 0.03 to 10 parts by weight per part by weight of the polymerization initiator.

As mentioned above, the inventive polymer latex may either be surfactant-free or comprise one or more surfactants. Accordingly, it is preferred that no surfactants are added before, during or after steps (1) and (2), in order to obtain a surfactant-free polymer latex.

The polymer latex of the present invention may further comprise protective colloids. The protective colloids may stabilize the polymer latex in addition or instead of the surfactants as described above. The protective colloids may be present during the polymerization or post-added. The protective colloids may comprise polyvinyl alcohol, vinyl alcohol-ethylene copolymer, silanol-modified polyvinyl alcohol, cellulose derivative, such as methylcellulose, ethylcellulose, hydroxycellulose and carboxycellulose, chitin, chitosan, starches, polyethylene glycol, polypropylene glycol, polyvinyl ether, gelatin, casein, cyclodextrin, and combinations thereof.

Typical quantities may be 1 to 15 parts by weight, based on 100 parts by weight of the polymer latex.

According to the present invention, the polymerization process may be carried out in any process variant known in the art, particularly monomers (b), (c) and (d) may be charged by batch, semi-batch, in a continuous charging manner, by split charging or by split injection. A skilled person will appreciate that these variants differ by how and when during the process these particular monomers are being added to the mixture of compounds.

These different process variants in combination with the inventive use of macro-RAFT agent (a) can enable the skilled person to prepare polymer latices comprising copolymers having predetermined monomer distributions and therefore predetermined properties, depending on the intended use of the respective obtained polymer latex.

The method according to the present invention may further comprise an additional step of charging additional monomers after the full amount of compounds (a), (b) and(c) have been charged into the reactor. Such monomers are preferably reactive with at least functional group present in compounds (a), (b) or (c).

It may further be beneficial to perform the emulsion polymerization additionally in the presence of buffer substances and chelating agents. Suitable substances are, for example, alkali metal phosphates and pyrophosphates (buffer substances) and the alkali metal salts of ethylenediaminetetraacetic acid (EDTA) or hydroxyl-2-ethylenediaminetriacetic acid (HEEDTA) as chelating agents. The quantity of buffer substances and chelating agents is usually 0.001-1.0 wt.-%, based on the total weight of compounds (a), (b), (c) and, if present, (d).

Furthermore, it may be advantageous to use chain transfer agents (regulators) in the emulsion polymerization. Typical agents are, for example, organic sulfur compounds, such as thioesters, 2-mercaptoethanol, 3-mercaptopropionic acid and C1-C12 alkyl mercaptans, n-dodecylmercaptan and t-dodecylmercaptan being preferred. The quantity of chain transfer agents, if present, is usually 0.05-3.0 wt.-%, preferably 0.2 2.0 wt.-%, based on the total weight of compounds (a), (b), (c) and, if present, (d) in the mixture of compounds.

The polymerization process according to the present invention may be carried out under mechanical agitation, i.e. stirring, in order to achieve optimal distribution of the reactants and to aid polymerization-induced self-assembly (PISA). The stirring speed may advantageously be from 80 to 400 rpm, preferably from 100 to 350 rpm or depending on the reactor design be as low as 50 rpm.

Furthermore, it can be beneficial to introduce partial neutralization to the polymerization process. A person skilled in the art will appreciate that by appropriate selection of this parameter the necessary control can be achieved.

Various other additives and ingredients can be added in order to prepare the polymer latex of the present invention. Such additives include, for example: antifoams, wetting agents, thickeners, plasticizers, fillers, pigments, dispersants, optical brighteners, crosslinking agents, accelerators, antioxidants, biocides and metal chelating agents. Known antifoams include silicone oils and acetylene glycols. Customary known wetting agents include alkylphenol ethoxylates, alkali metal dialkylsulfosuccinates, acetylene glycols and alkali metal alkylsulfate. Typical thickeners include polyacrylates, polyacrylamides, xanthan gums, modified celluloses or particulate thickeners, such as silicas and clays. Typical plasticizers include mineral oil, liquid polybutenes, liquid polyacrylates and lanolin. Zinc oxide is a suitable crosslinking agent. Titanium dioxide (TiO2), calcium carbonate and clay are the fillers typically used. Known accelerators and secondary accelerators include dithiocarbamates like zinc diethyl dithiocarbamate, zinc dibutyl dithiocarbamate, zinc dibenyl dithiocarbamate, zinc pentamethylene dithiocarbamate (ZPD), xanthates, thiurams like tetramethylthiuram monosulfide (TMTM), tetramethylthiuram disulfide (TMTD), tetraethylthiuram disulfide (TETD), dipentamethylenethiuram hexasulfide (DPTT), and amines, such as diphenylguanidine (DPG), di-o-tolylguanidine (DOTG), and o-tolylbiguanidine (OTBG).

### Rubber Articles

The polymer latex is particularly useful for the production of rubber articles. Accordingly, the present invention also refers to the use of a polymer latex according to the present invention for the production of rubber articles and rubber articles prepared from a polymer latex according to the present invention. Such rubber articles may comprise surgical gloves, examination gloves, condoms, catheters, industrial gloves, textile-supported gloves, household gloves balloons, tubing, dental dams, aprons and pre-formed gaskets. Such rubber articles may be prepared using techniques commonly known in the art, including, for example, dip molding.

### EXAMPLES

The following examples are intended to further illustrate the present invention but are not intended to limit the scope of the present invention in any way.

In the following all parts and percentages are based on weight unless otherwise specified.

### Synthesis of Macro-RAFT Polymer (Macro-RAFT) Examples

A 250 mL or 2000 mL reactor equipped with a mechanical anchor stirrer, nitrogen inlet, and temperature-controlled system was charged into the reactor with RAFT agent, 4-((((2-carboxyethyl)thio)-carbonothioyl)thio)-4-cyanopentanoic acid (BM1433 by Boron Molecular) and activator, with molar ratio of RAFT agent to activator of 1:0.1, alongside deionized water. The mixture was stirred and bubbled under a nitrogen flow for 20 minutes. Subsequently, the temperature of the mixture was raised to 60° C. and previously degassed monomer, with a fixed molar ratio of RAFT agent to monomer was added into the reactor, then the temperature was immediately raised to 80° C. The solution turned yellow rapidly and all materials were solubilized. The temperature and stirring are maintained for 2 to 4 hours to obtain at least 95.0% yield of Macro-RAFT Polymer. For the synthesized Macro-RAFT polymer examples, the mole ratio of RAFT agent to monomer and activator used, the type of monomer and activator used and its target molecular weight (Mw) are shown in Table 1.

TABLE 1
Macro-RAFT

| Examples | | | | |
|---|---|---|---|---|
| of Macro- | | | | |
| RAFT | Monomer | | Activator | |
| Polymer | Type | Ratio* | Type | Target Mw |
| 1 | MAA | 8.0 | 4,4′-Azobis(4-cyanopentanoic | 1000 |
| | | | acid), ACPA | |
| 2 | MAA | 19.7 | Sodium Persulfate, NaPS | 2000 |
| 3 | MAA | 19.7 | 4,4′-Azobis(4-cyanopentanoic | 2000 |
| | | | acid), ACPA | |
| 4 | AA | 23.5 | 4,4′-Azobis(4-cyanopentanoic | 2000 |
| | | | acid), ACPA | |
| 5 | MAA | 48.7 | 4,4′-Azobis(4-cyanopentanoic | 4500 |
| | | | acid), ACPA | |

*per 1 mole of RAFT agent

Synthesis of Carboxylated Nitrile Butadiene (XNBR) Latex using Macro-RAFT Polymer.

### Example 1

3.0 parts of Macro-RAFT Example 3, 33 parts of 0.5M aqueous solution of sodium hydroxide (NaOH), 0.0012 parts of sodium ethylenediaminetetraacetic acid (Na4EDTA) and 117.1 parts of water were added into the reactor vessel and pre-heated to 30° C. Subsequently, 31.0 parts of acrylonitrile (ACN) was dumped into the reactor together with 0.05 parts of activator, cumene hydroperoxide (CHP). The reactor was put under vacuum and refilled with nitrogen six times to remove oxygen. Then 66.0 parts of butadiene (BD) was added into the reactor. The temperature of mixture was maintained at 30° C. and stirred at 350 rpm. Finally, 0.03 parts of sodium formaldehyde sulfoxylate (SFS) in water was added into the reactor to start the reaction. Samples were taken during the polymerization to follow up with the conversion. When conversion is close to 100%, the reactor was cooled to room temperature. In order to remove residual monomers, the reactor is put under vacuum and nitrogen flow for 1 h.

### Example 2

2.0 parts of Macro-RAFT Example 3, 22 parts of 0.5M aqueous solution of NaOH, 0.0012 parts of Na4EDTA and 128.0 parts of water were added into the reactor vessel and pre-heated to 30° C. Subsequently, 31.3 parts of ACN was dumped into the reactor together with 0.05 parts of activator, CHP. The reactor was put under vacuum and refilled with nitrogen six times to remove oxygen. Then 66.7 parts of BD is added into the reactor. The mixture was maintained at 30° C. and stirred at 350 rpm. Finally, 0.03 parts of SFS in water was added into the reactor to start the reaction. Samples were taken during the polymerization to follow up with the conversion. When conversion is close to 100%, the reactor was cooled to room temperature. In order to remove residual monomers, the reactor is put under vacuum and nitrogen flow for 1 h.

### Example 3

The procedure is identical to Example 2 except with the addition of 0.6 parts of tertiary dodecyl mercaptan (tDM) in the reactor with the ACN.

### Example 4

5.8 parts of Macro-RAFT Example 5, 28.5 parts of 0.5M aqueous solution of NaOH, 0.0012 parts of Na4EDTA and and 121.6 parts of water was added into the reactor vessel and pre-heated to 30° C. Subsequently, 30.1 parts of ACN were dumped into the reactor together with 0.05 parts of activator, CHP. The reactor is put under vacuum and refilled with nitrogen six times to remove oxygen. Then 64.1 parts of BD is added into the reactor. The mixture is heated at 30° C. and stirred at 350 rpm. Finally, 0.03 parts of SFS in water is added into the reactor to start the reaction. Samples were taken during the polymerization to follow up with the conversion. When conversion is close to 100%, the reactor was cooled to room temperature. In order to remove residual monomers, the reactor is put under vacuum and nitrogen flow for 1 h.

### Example 5

3.0 parts of Macro-RAFT Example 1, 36.0 parts of 0.5M aqueous solution of sodium hydroxide, 0.0024 of Na4EDTA and 114.2 parts of water were added into the reactor vessel and pre-heated to 30° C. Subsequently, 31 parts of ACN was dumped into the reactor together with 0.09 parts of activator, CHP. The reactor was put under vacuum and refilled with nitrogen six times to remove oxygen. Then 66.0 parts of BD was added into the reactor. The mixture was heated at 30° C. and stirred at 350 rpm. Finally, 0.05 parts of SFS in water is added into the reactor to start the reaction. Samples were taken during the polymerization to follow up with the conversion. When conversion is close to 100%, the reactor was cooled to room temperature. In order to remove residual monomers, the reactor is put under vacuum and nitrogen flow for 1 h.

### Example 6

3.0 parts by weight Macro-RAFT Example 2, 0.67 parts by weight of 5% aqueous solution of NaOH (NaOH 5%) were added into the reactor vessel and pre-heated to 30° C. Subsequently, monomers (31.0 parts by weight of ACN and 66.0 parts by weight of BD) were dumped into the reactor together with 0.6 parts by weight of tDM followed by 0.01 parts by weight of Na4EDTA and co-activator, 0.0262 parts by weight of SFS dissolved in 4 parts of water and 0.0474 parts by weight of activator, CHP were added into a 3 times nitrogen-purged reactor vessel while the temperature and stirring were maintained at 30° C. and 150 rpm respectively.

Additional 0.0474 parts by weight CHP was added after 6th hour and 0.0262 parts by weight of SFS was added after 7th hour. Subsequently, the temperature was raised to 45° C. from 8th hour and the temperature was raised again to 60° C. from 9th hour and maintained up to a conversion of 95%, resulting in a total solids content of 40%. The polymerization was short-stopped by addition of 0.0474 parts by weight of isopropylhydroxylamine, IPHA.

The pH was adjusted using 5% aqueous solution of potassium hydroxide (KOH 5%) to pH 7.0 and the residual monomers were removed by vacuum distillation at 60° C. for at least 8 h. Then, 0.5 parts by weight of a Wingstay L type antioxidant (60% dispersion in water) was added to the raw latex, and the pH was adjusted again to 8.0 by addition of a KOH 5%. Wherein, all parts added were based on total solid content.

### Example 7

3.0 parts by weight Macro-RAFT Example 2, 0.67 parts by weight of NaOH 5% were added into the reactor vessel and pre-heated to 30° C. with stirring maintained at 150 rpm. Then 0.01 parts by weight of Na4EDTA and 0.005 parts by weight of Bruggolite FF6 dissolved in 2 parts by weight of water were added, followed by 0.08 parts by weight of sodium persulfate (NaPS) dissolved in 2 parts by weight of water. Then, the monomers (35.0 parts by weight of ACN and 62.0 parts by weight of BD), and were added together with 0.6 parts by weight of tDM over a period of 6 hours. At the same time, the co-activator feed rate of 0.0143 parts by weight per hour of Bruggolite FF6 was added. The temperature was maintained at 30° C. until 8th hour, then raised to 45° C. and maintained up to a conversion of 95%, resulting in a total solids content of 40%. The polymerization was short-stopped by addition of 0.0474 parts by weight of isopropylhydroxylamine, IPHA.

The pH was adjusted using KOH 5% to pH 7.0 and the residual monomers were removed by vacuum distillation at 60° C. 0.5 parts by weight of a Wingstay L type antioxidant (60% dispersion in water) was added to the raw latex, and the pH was adjusted again to 8.0 by addition of a KOH 5%. Wherein, all parts added were based on total solid content

### Example 8

The procedure is identical to Example 7 except that the reactor temperature was raised and maintained at 45° C. throughout the polymerization.

### Example 9

The procedure is identical to Example 8 except that 60 parts by weight BD was used and additional 2.0 parts by weight of MAA was dosed at 9th hour in 5 min.

### Example 10

The procedure is identical to Example 8 except that 60 parts by weight of BD was used and additional 2.0 parts by weight of MAA was fed at 5th hour in 6 h.

### Example 11

2.0 parts by weight (based on polymer solids) of a seed latex (average particle size 36 nm) and 3.0 parts by weight Macro-RAFT Example 2 based on 100 parts by weight of monomer including the seed latex were added to a nitrogen-purged autoclave and subsequently heated to 30° C. Then 0.01 parts by weight of Na4EDTA and 0.005 parts by weight of Bruggolite FF6 dissolved in 2 parts by weight of water were added, followed by 0.08 parts by weight of NaPS dissolved in 2 parts by weight of water. Then, the monomers (35.0 parts by weight of ACN, 57.0 parts by weight of BD, 3.0 parts by weight of MAA), and were added together with 0.6 parts by weight of tDM over a period of 6 hours. Over a period of 10 hours 2.2 parts by weight of sodium dodecyl benzene sulfonate, 0.2 parts by weight of tetra sodium pyrophosphate and 22 parts by weight of water were added. The co-activator feed of 0.10 parts by weight of Bruggolite FF6 in 8 parts by weight of water was added over 9 hours. The polymerization temperature started at 30° C. and ended at 60° C., up to a conversion of 95%, resulting in a total solids content of 40%.

The polymerization was short-stopped by addition of 0.08 parts by weight of IPHA solution. The pH was adjusted using KOH 5% to pH 7.0 and the residual monomers were removed by vacuum distillation at 60° C. 0.5 parts by weight of a Wingstay L type antioxidant (60% dispersion in water) was added to the raw latex, and the pH was adjusted again to 8.0 by addition of KOH 5%.

### Example 12

The procedure is identical to Example 11 except that 54.0 parts by weight of BD and 6.0 parts by weight of MAA were used.

### Example 13

The procedure is identical to Example 11 except that 0.88 parts by weight of sodium dodecyl benzene sulfonate was feed over a period of 5 hours.

TABLE 2

| | | | | | Macro-RAFT | | | | | | |
|---|---|---|---|---|---|---|---|---|---|---|---|
| | | | | | | Macro- | Transfer | | Stirring | | Particle |
| | Polymerization | Monomer (parts) | | | | RAFT | agent | Temperature | Speed | Conversion | Size |
| Examples | Mode | BD | ACN | MAA | Parts | Polymer | (parts) | Profile | (rpm) | (%) | (nm) |
| Example | Non-Seeded; | 66.0 | 31.0 | 0.0 | 3.0 | Macro- | — | 30 °C | 350 | 94 | 71 |
| 1 | Batch | | | | | RAFT | | | | | |
| | | | | | | Example | | | | | |
| | | | | | | 3 | | | | | |
| Example | Non-Seeded; | 66.7 | 31.3 | 0.0 | 2.0 | Macro- | — | 30 °C | 350 | 93 | 93 |
| 2 | Batch | | | | | RAFT | | | | | |
| | | | | | | Example | | | | | |
| | | | | | | 3 | | | | | |
| Example | Non-Seeded; | 66.7 | 31.3 | 0.0 | 2.0 | Macro- | 0.6 | 30 °C | 350 | 97 | 87 |
| 3 | Batch | | | | | RAFT | | | | | |
| | | | | | | Example | | | | | |
| | | | | | | 3 | | | | | |
| Example | Non-Seeded; | 64.1 | 30.1 | 0.0 | 5.8 | Macro- | — | 30 °C | 350 | 98 | 82 |
| 4 | Batch | | | | | RAFT | | | | | |
| | | | | | | Example | | | | | |
| | | | | | | 5 | | | | | |
| Example | Non-Seeded; | 66.0 | 31.0 | 0.0 | 3.0 | Macro- | — | 30 °C | 350 | 92 | 64 |
| 5 | Batch | | | | | RAFT | | | | | |
| | | | | | | Example | | | | | |
| | | | | | | 1 | | | | | |
| Example | Non-Seeded; | 66.0 | 31.0 | 0.0 | 3.0 | Macro- | 0.6 | 30 °C/45 °C/ | 150 | 94 | 95 |
| 6 | Batch | | | | | RAFT | | 60 °C | | | |
| | | | | | | Example | | | | | |
| | | | | | | 2 | | | | | |
| Example | Non-Seeded; | 62.0 | 35.0 | 0.0 | 3.0 | Macro- | 0.6 | 30 °C/45 °C | 150 | 100 | 105 |
| 7 | Semi-Batch | | | | | RAFT | | | | | |
| | | | | | | Example | | | | | |
| | | | | | | 2 | | | | | |
| Example | Non-Seeded; | 62.0 | 35.0 | 0.0 | 3.0 | Macro- | 0.6 | 45 °C | 150 | 95 | 96 |
| 8 | Semi-Batch | | | | | RAFT | | | | | |
| | | | | | | Example | | | | | |
| | | | | | | 2 | | | | | |
| Example | Non-Seeded; | 60.0 | 35.0 | 2.0 | 3.0 | Macro- | 0.6 | 45 °C | 150 | 78 | 156 |
| 9 | Semi-Batch | | | | | RAFT | | | | | |
| | | | | | | Example | | | | | |
| | | | | | | 2 | | | | | |
| Example | Non-Seeded; | 60.0 | 35.0 | 2.0 | 3.0 | Macro- | 0.6 | 45 °C | 150 | 58 | 165 |
| 10 | Semi-Batch | | | | | RAFT | | | | | |
| | | | | | | Example | | | | | |
| | | | | | | 2 | | | | | |
| Example | Seeded; | 57.0 | 35.0 | 3.0 | 3.0 | Macro- | 0.6 | 30 °C | 100 | 99 | 107 |
| 11 | Semi-Batch | | | | | RAFT | | | | | |
| | | | | | | Example | | | | | |
| | | | | | | 2 | | | | | |
| Example | Seeded; | 54.0 | 35.0 | 6.0 | 3.0 | Macro- | 0.6 | 30/60 °C | 100 | 97 | 105 |
| 12 | Semi-Batch | | | | | RAFT | | | | | |
| | | | | | | Example | | | | | |
| | | | | | | 2 | | | | | |
| Example | Seeded; | 57.0 | 35.0 | 3.0 | 3.0 | Macro- | 0.6 | 30/60 °C | 100 | 91 | 115 |
| 13 | Semi-Batch | | | | | RAFT | | | | | |
| | | | | | | Example | | | | | |
| | | | | | | 2 | | | | | |

1. A polymer latex comprising a copolymer obtained by free radical emulsion polymerization of a mixture of compounds comprising:
(a) a macro-reversible addition-fragmentation chain-transfer (macro-RAFT) agent obtained by free radical polymerization of a RAFT agent (a1) with an ethylenically unsaturated monomer having at least one acid, hydroxyl, ester, ether, amine, sulphonate and/or amide functional group (a2),
(b) an ethylenically unsaturated monomer having a nitrile functional group; and
(c) a conjugated diene monomer.

2. The polymer latex according to claim 1, wherein the mixture of compounds further comprises
(d) an ethylenically unsaturated monomer having at least carboxylic acid, ester, ether, sulphonate, hydroxyl, primary amine, secondary amine or sulphate functional group.

3. The polymer latex according to claim 1, wherein the RAFT agent (a1) comprises a compound having a thiocarbonyl functional group.

4. The polymer latex according to claim 3, wherein the thiocarbonyl functional group comprises a trithiocarbonate, dithioester, a thiocarbamate and/or a xanthate functional group.

5. The polymer latex according to claim 1, wherein the macro-RAFT agent (a) is capable of inducing polymerization induced self-assembly (PISA).

6. The polymer latex according to claim 1, wherein monomer (b) comprises monomers having a total number of 3 to 10 carbon atoms and combinations thereof.

7. (canceled)

8. The polymer latex according to claim 1, wherein monomers (a2) and/or (d) comprise monomers of the general formula
R¹C(═CH₂)R²X,
wherein R¹ is H, methyl or ethyl, R² is an optional, linear or branched spacer group having 1 to 5 carbon atoms, and X is a carboxylic acid, ester, ether, sulphonate, hydroxyl, primary amine, secondary amine or sulphate functional group.

9. (canceled)

10. (canceled)

11. (canceled)

12. The polymer latex according to claim 2, wherein the content of monomer (b) in the mixture of compounds is from 15 to 60 parts by weight, based on the weight of mixture of compounds.

13. The polymer latex according to claim 1, wherein the content of monomer (c) in the mixture of compounds is from 40 to 90 parts by weight, based on the weight of mixture of compounds.

14. The polymer latex according to claim 1, wherein the macro-RAFT agent (a) is present in an amount between 1.5 and 10 parts by weight, based on the weight of mixture of compounds.

15. The polymer latex according to claim 2, wherein monomer (d) is present in an amount between 0.5 and 20 parts by weight, based on the weight of mixture of compounds.

16. (canceled)

17. The polymer latex according to claim 1 is a surfactant-free polymer latex.

18. A method for producing a polymer latex comprising a copolymer, the method comprising the steps of
(1) free radical polymerization of a RAFT agent (a1) with an ethylenically unsaturated monomer having at least one acid, hydroxyl, ester, amine and/or amide functional group (a2) to receive a macro-RAFT agent (a),
(2) RAFT-mediated emulsion polymerization of a mixture of compounds comprising:
(a) the macro-RAFT agent (a) received in step (1);
(b) an ethylenically unsaturated monomer having a nitrile functional group; and
(c) a conjugated diene monomer
to obtain the polymer latex.

19. The method according to claim 18, wherein the method further comprising adding at least one ethylenically unsaturated monomer having at least one acid, hydroxyl, ester, amine and/or amide functional group (a2) and/or (d) to the reaction mixture during and/or after step (2).

20. The method according to claim 19, wherein wherein monomers (b), (c) and/or (d) are charged by batch, semi-batch, continuous, split charging or split injection.

21. (canceled)

22. The method according to claim 19, wherein no surfactants are added before, during or after steps (1) and (2).

23. The method according to claim 19, wherein no seeding agents are added before, during or after steps (1) and (2).

24. The method according to claim 19, wherein the polymerization of step (2) is carried out at a temperature between 5° C. to 95° C.

25. (canceled)

26. (canceled)

27. A rubber article prepared from the polymer latex according to claim 1.

28. The rubber article according to claim 27, wherein the rubber article comprises a surgical glove, an examination glove, a condom, a catheter, an industrial glove, a textile-supported glove, a household glove balloon, a tubing, a dental dam, an apron and a pre-formed gasket.
